(19) United States
(12) Patent Application Publication
(10) Pub. No.: US 2019/0275774 A1
(43) Pub. Date: Sep. 12, 2019

(54) POLYPROPYLENE-BASED FOAM SHEET AND POLYPROPYLENE-BASED FOAM MULTILAYER SHEET

(71) Applicant: MITSUI CHEMICALS TOHCELLO, INC., Chiyoda-ku, Tokyo (JP)

(72) Inventors: Tomoya Matayoshi, Ichihara-shi, Chiba (JP); Takayuki Watanabe, Chiba-shi-Chiba (JP); Michio Eriguchi, Chiba-shi-Chiba (JP)

(73) Assignee: MITSUI CHEMICALS TOHCELLO, INC., Chiyoda-ku, Tokyo (JP)

(21) Appl. No.: 16/345,312

(22) PCT Filed: Oct. 11, 2017
(86) PCT No.: PCT/JP2017/036888

§ 371 Date: Apr. 26, 2019

(30) Foreign Application Priority Data
Oct. 31, 2016 (JP) 2016-213791

(51) Int. Cl. B32B 27/32; B32B 5/18; C08K 3/34; C08L 23/10; C08K 3/013

(52) U.S. Cl. CPC B32B 27/32; B32B 5/18; C08K 3/34; C08L 23/10; B32B 2307/51; B32B 2419/06; B32B 2607/00; B32B 2307/72; C08K 3/013

(57) ABSTRACT

A polypropylene-based foam sheet (100) of the present invention is a polypropylene-based foam sheet including a polypropylene-based resin; and an inorganic filler, in which the inorganic filler includes one or more selected from talc, mica, and silica, and a content of the inorganic filler in the polypropylene-based foam sheet is equal to or more than 15 parts by mass and equal to or less than 65 parts by mass when a total amount of the polypropylene-based resin and the inorganic filler is set to 100 parts by mass.

### TECHNICAL FIELD

The present invention relates to a polypropylene-based foam sheet and a polypropylene-based foam multilayer sheet.

### BACKGROUND ART

Wooden boards such as hardboards and medium-density fiberboards are light in weight and have excellent mechanical characteristics and are thus used as, for example, construction materials, furniture, partition materials, heat insulation materials, packing materials, and the like.

As techniques relating to the above-described wooden boards, for example, techniques described in Patent Document 1 (Japanese Unexamined Patent Publication No. 2014-151599) and Patent Document 2 (Japanese Unexamined Patent Publication No. 2010-64306) are exemplified.

Patent Document 1 describes a wooden board which is formed by adhering wooden chips or a wood fiber using an adhesive and molding the wooden chips or the wood fiber and contains a parenchymatous cell-removed bamboo fiber that is obtained by removing a parenchymatous cell from a bamboo fiber obtained by fracturing a bamboo.

In addition, Patent Document 2 describes a wooden board which is obtained by molding a wood material under heat and pressure together with an adhesive and includes 0.1% by weight to 30% by weight of fine powder of sodium sulfite having an average grain diameter of equal to or more than 40 μm and equal to or less than 180 μm with respect to the total dried weight of the wood material.

### RELATED DOCUMENT

### Patent Document

[Patent Document 1] Japanese Unexamined Patent Publication No. 2014-151599

[Patent Document 2] Japanese Unexamined Patent Publication No. 2010-64306

### SUMMARY OF THE INVENTION

### Technical Problem

From the viewpoint of global environment preservation, deforestation is suppressed, and the procurement of wood resources is anticipated to become difficult, and thus there is a demand for a replacement of wooden boards.

The present invention has been made in consideration of the above-described circumstance and provides a polypropylene-based foam sheet and a polypropylene-based foam multilayer sheet which are excellent in terms of the performance balance between the lightweight property and the mechanical characteristics and are preferred as a replacement of wooden boards.

### Solution to Problem

The present inventors carried out intensive studies in order to realize a replacement of wooden boards which is excellent in terms of the performance balance between the lightweight property and the mechanical characteristics. As a result, the present inventors found that a polypropylene-based foam sheet obtained by foaming a resin composition in which an inorganic filler is blended into a polypropylene-based resin at a specific proportion is excellent in terms of the performance balance between the lightweight property and the mechanical characteristics.

That is, according to the present invention, a polypropylene-based foam sheet and a polypropylene-based foam multilayer sheet which will be described are provided.

[1] A polypropylene-based foam sheet including: a polypropylene-based resin; and an inorganic filler, in which the inorganic filler includes one or more selected from talc, mica, and silica, and

a content of the inorganic filler in the polypropylene-based foam sheet is equal to or more than 15 parts by mass and equal to or less than 65 parts by mass when a total amount of the polypropylene-based resin and the inorganic filler is set to 100 parts by mass.

[2] The polypropylene-based foam sheet according to [1], in which the inorganic filler includes talc.

[3] The polypropylene-based foam sheet according to [1] or [2], in which a density of the polypropylene-based foam sheet is equal to or less than 1.0 g/cm³.

[4] The polypropylene-based foam sheet according to any one of [1] to [3],

in which a bending elastic modulus of the polypropylene-based foam sheet, which is measured in an environment of 23° C. and 50% RH, is equal to or more than 1.0 GPa.

[5] The polypropylene-based foam sheet according to any one of [1] to [4],

in which a Young's modulus of the polypropylene-based foam sheet, which is measured in an environment of 23° C. and 50% RH under conditions of a test specimen shape of a strip shape, a test specimen width of 10 mm, an inter-chuck distance of 50 mm, and a tensile rate of 20 mm/minute, is equal to or more than 0.3 GPa.

[6] The polypropylene-based foam sheet according to any one of [1] to [5],

in which an arithmetic average roughness Ra of a surface of the polypropylene-based foam sheet, which is measured on the basis of JIS-B0601-1994, is equal to or less than 2.5 μm.

[7] The polypropylene-based foam sheet according to any one of [1] to [6],

in which a total of contents of the polypropylene-based resin and the inorganic filler in the polypropylene-based foam sheet is equal to or more than 50% by mass and equal to or less than 100% by mass when the entire polypropylene-based foam sheet is set to 100% by mass.

[8] The polypropylene-based foam sheet according to any one of [1] to [7],

in which a melt flow rate of the polypropylene-based resin, which is based on ASTM D1238 and measured under conditions of 230° C. and a load of 2.16 kg, is equal to or more than 0.5 g/10 minutes and equal to or less than 20 g/10 minutes.

[9] The polypropylene-based foam sheet according to any one of [1] to [8],

in which a Z average molecular weight (Mz)/weight-average molecular weight (Mw) of the polypropylene-based resin, which is measured by gel permeation chromatography (GPC), is equal to or more than 7 and equal to or less than 20.

[10] The polypropylene-based foam sheet according to any one of [1] to [9],

in which a thickness of the polypropylene-based foam sheet is equal to or more than 0.5 mm and equal to or less than 30 mm.

[11] The polypropylene-based foam sheet according to any one of [1] to [10] which is used as a replacement of a wooden board.

[12] A polypropylene-based foam multilayer sheet including:

a polypropylene-based foam layer constituted of the polypropylene-based foam sheet according to any one of [1] to [11];

a first non-foaming resin layer that is provided on one surface of the polypropylene-based foam layer and includes a thermoplastic resin and an inorganic filler; and

a second non-foaming resin layer that is provided on the other surface of the polypropylene-based foam layer and includes a thermoplastic resin and an inorganic filler.

[13] The polypropylene-based foam multilayer sheet according to [12],

in which thicknesses of the first non-foaming resin layer and the second non-foaming resin layer are respectively equal to or more than 0.05 mm and equal to or less than 5 mm.

[14] The polypropylene-based foam multilayer sheet according to [12] or [13],

in which a ratio of the thickness of the first non-foaming resin layer to a thickness of the entire polypropylene-based foam multilayer sheet is equal to or more than 0.01 and equal to or less than 0.5, and

a ratio of the thickness of the second non-foaming resin layer to the thickness of the entire polypropylene-based foam multilayer sheet is equal to or more than 0.01 and equal to or less than 0.5.

[15] The polypropylene-based foam multilayer sheet according to any one of [12] to [14],

in which the inorganic fillers in the first non-foaming resin layer and the second non-foaming resin layer respectively include one or more selected from talc, mica, and silica.

[16] The polypropylene-based foam multilayer sheet according to any one of [12] to [15],

in which contents of the inorganic fillers in the first non-foaming resin layer and the second non-foaming resin layer are respectively equal to or more than 5 parts by mass and equal to or less than 90 parts by mass when a total amount of the thermoplastic resins and the inorganic fillers included in the first non-foaming resin layer and the second non-foaming resin layer is set to 100 parts by mass.

[17] The polypropylene-based foam multilayer sheet according to any one of [12] to [16],

in which the first non-foaming resin layer and the second non-foaming resin layer have the same composition and the same thickness.

[18] The polypropylene-based foam multilayer sheet according to any one of [12] to [17] which is used as a replacement of a wooden board.

### Advantageous Effects of Invention

According to the present invention, it is possible to realize a polypropylene-based foam sheet and a polypropylene-based foam multilayer sheet which are excellent in terms of the performance balance between the lightweight property and the mechanical characteristics and are preferred as a replacement of wooden boards.

### BRIEF DESCRIPTION OF THE DRAWINGS

The above-described object, other objects, characteristics, and advantages will be further clarified using a preferred embodiment described below and the accompanying drawings below.

FIG. 1 is a cross-sectional view schematically showing an example of a structure of a polypropylene-based foam sheet of an embodiment according to the present invention.

FIG. 2 is a cross-sectional view schematically showing an example of a structure of a polypropylene-based foam multilayer sheet of the embodiment according to the present invention.

### DESCRIPTION OF EMBODIMENTS

Hereinafter, an embodiment of the present invention will be described using drawings. Meanwhile, unless particularly otherwise described, a numerical range “A to B” indicates equal to and more than A and equal to and less than B.

1. Regarding Polypropylene-Based Foam Sheet

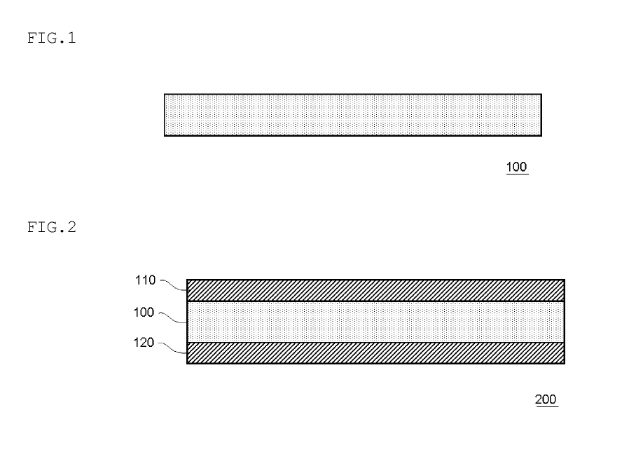

FIG. 1 is a cross-sectional view schematically showing an example of the structure of a polypropylene-based foam sheet 100 of an embodiment according to the present invention.

The polypropylene-based foam sheet 100 according to the present embodiment includes a polypropylene-based resin and an inorganic filler, and the inorganic filler includes one or more selected from talc, mica, and silica.

In addition, the content of the inorganic filler in the polypropylene-based foam sheet 100 is equal to or more than 15 parts by mass, preferably equal to or more than 25 parts by mass, more preferably equal to or more than 35 parts by mass, still more preferably equal to or more than 45 parts by mass, and particularly preferably equal to or more than 55 parts by mass when the total amount of the polypropylene-based resin and the inorganic filler is set to 100 parts by mass.

In addition, the content of the inorganic filler in the polypropylene-based foam sheet 100 is equal to or less than 65 parts by mass and preferably equal to or less than 60 parts by mass when the total amount of the polypropylene-based resin and the inorganic filler is set to 100 parts by mass.

As described above, from the viewpoint of global environment preservation, deforestation is suppressed, and the procurement of wood resources is anticipated to become difficult, and thus there is a demand for a replacement of wooden boards.

Therefore, the present inventors carried out intensive studies in order to realize a replacement of wooden boards being excellent in terms of the performance balance between the lightweight property and the mechanical characteristics. As a result, the present inventors found that a polypropylene-based foam sheet obtained by foaming a resin composition in which an inorganic filler is blended into a polypropylene-based resin at a specific proportion is excellent in terms of the performance balance between the lightweight property and the mechanical characteristics.

That is, according to the polypropylene-based foam sheet 100 according to the present embodiment, the polypropylene-based resin and one or more inorganic fillers selected from talc, mica, and silica are used in combination, and the content of the inorganic filler is set to equal to or more than the above-described lower limit value, and thus it is possible to improve the mechanical characteristics such as the bending characteristics or the tensile characteristics, the heat resistance, the moisture resistance, the dimensional stability, and the like of the polypropylene-based foam sheet 100.

In addition, according to the polypropylene-based foam sheet 100 according to the present embodiment, the polypropylene-based resin and one or more inorganic fillers selected from talc, mica, and silica are used in combination, and the content of the inorganic filler is set to equal to or more than the above-described lower limit value, and thus it is possible to make the balance between the lightweight property and the high stiffness of the polypropylene-based foam sheet 100 more favorable and improve the moldability of the polypropylene-based foam sheet 100 or the uniformity of foam cells or suppress the generation of holes in the polypropylene-based foam sheet 100 or sheet breakage and, consequently, the polypropylene-based foam sheet 100 having an excellent appearance can be realized.

Furthermore, according to the polypropylene-based foam sheet 100 according to the present embodiment, one or more selected from talc, mica, and silica are included as the inorganic filler and thus it is possible to reduce the weight of the polypropylene-based foam sheet 100 more compared with a case in which, for example, calcium carbonate is used as the inorganic filler.

In addition, according to the polypropylene-based foam sheet 100 according to the present embodiment, one or more selected from talc, mica, and silica are included as the inorganic filler and thus it is possible to make the appearance of the polypropylene-based foam sheet 100 more favorable compared with a case in which, for example, a glass fiber is used as the inorganic filler.

Meanwhile, a glass fiber fuzzes, which makes the handling of the glass fiber difficult, furthermore, makes the glass fiber exposed on the surface or end portion of the sheet, and deteriorates the appearance of the sheet, and thus the glass fiber is not preferred.

In addition, in the polypropylene-based foam sheet 100 according to the present embodiment, a polypropylene-based resin which is plastic is used, and thus the polypropylene-based foam sheet has a superior water resistance and is capable of maintaining superior mechanical characteristics even when be wetted by water or left to stand for a long period of time in a highly humid environment compared to wooden boards. In addition, the polypropylene-based foam sheet 100 according to the present embodiment, unlike wooden boards, does not easily allow the generation of chips and also has an excellent handleability.

The density of the polypropylene-based foam sheet 100 is preferably equal to or less than 1.0 g/cm³ and more preferably less than 1.0 g/cm³. When the density is equal to or less than or less than the above-described upper limit value, it is possible to obtain the polypropylene-based foam sheet 100 being lighter in weight. In addition, when the density is equal to or less than or less than the above-described upper limit value, the polypropylene-based foam sheet is capable of floating in water, and thus it becomes easier to differentiate constituent components, and it is possible to improve the recycle property.

In addition, the density of the polypropylene-based foam sheet 100 is preferably equal to or more than 0.35 g/cm³, more preferably equal to or more than 0.40 g/cm³, still more preferably equal to or more than 0.45 g/cm³, and particularly preferably equal to or more than 0.50 g/cm³. When the density is equal to or more than the above-described lower limit value, it is possible to further improve the mechanical characteristics such as the bending characteristics or the tensile characteristics of the polypropylene-based foam sheet 100.

The density of the polypropylene-based foam sheet 100 can be controlled to be in the above-described range by appropriately controlling, for example, the kinds or blending amounts of the polypropylene-based resin, the inorganic filler, and the like, the expansion ratio of the polypropylene-based foam sheet 100, and the like respectively.

The bending elastic modulus of the polypropylene-based foam sheet 100 according to the present embodiment, which is measured in an environment of 23° C. and 50% RH, is preferably equal to or more than 1.0 GPa, more preferably equal to or more than 1.5 GPa, still more preferably equal to or more than 2.0 GPa, far still more preferably equal to or more than 2.5 GPa, and particularly preferably equal to or more than 3.0 GPa.

When the bending elastic modulus is equal to or more than the above-described lower limit value, it is possible to further improve the stiffness of the polypropylene-based foam sheet 100 and, consequently, it is possible to suppress the deformation of the polypropylene-based foam sheet 100 caused by an external stress or improve the damage resistance, the heat resistance, the dimensional stability, and the like of the polypropylene-based foam sheet 100.

In addition, the bending elastic modulus of the polypropylene-based foam sheet 100 according to the present embodiment is preferably equal to or less than 10 GPa and more preferably equal to or less than 9 GPa.

When the bending elastic modulus is equal to or less than the above-described upper limit value, it is possible to make the balance between the deformation resistance to an external stress and the toughness of the polypropylene-based foam sheet 100 more favorable.

Here, the bending elastic modulus of the polypropylene-based foam sheet 100 can be measured by a three-point bend test. For example, with reference to the bending strength test described in JIS A5905, a deflection quantity Y [mm] with respect to a testing load F [N] is measured in an environment of 23° C. and 50% RH under conditions of a test specimen thickness t of 3 mm, a test specimen width b of 50 mm, a test specimen length of 150 mm, an inter-span distance L of 100 mm, and a bending rate of 50 mm/minute. A gradient ΔF/ΔY of the initial straight portion in the obtained load to deflection diagram is obtained, and the bending elastic modulus E [GPa] is obtained from Expression (1).

E={L³/(4b·t³)}·(ΔF/ΔY) (1)

The bending elastic modulus with respect to the testing load are measured respectively at one point in the MD direction and at one point in the TD direction, and the average value thereof can be employed as the bending elastic modulus.

The bending elastic modulus of the polypropylene-based foam sheet 100 can be controlled to be in the above-described range by appropriately controlling, for example, the kinds or blending amounts of the polypropylene-based resin, the inorganic filler, and the like, the expansion ratio of the polypropylene-based foam sheet 100, and the like respectively.

The Young's modulus of the polypropylene-based foam sheet 100 is preferably equal to or more than 0.3 GPa, more preferably equal to or more than 0.5 GPa, still more preferably equal to or more than 0.8 GPa, and particularly preferably equal to or more than 1.0 GPa.

When the Young's modulus is set to equal to or more than the above-described lower limit value, it is possible to further improve the stiffness of the polypropylene-based foam sheet 100 and, consequently, it is possible to suppress the deformation of the polypropylene-based foam sheet 100 caused by an external stress or improve the damage resistance, the heat resistance, the dimensional stability, and the like of the polypropylene-based foam sheet 100.

In addition, the Young's modulus of the polypropylene-based foam sheet 100 according to the present embodiment is preferably equal to or less than 5 GPa and more preferably equal to or less than 3 GPa.

When the Young's modulus is equal to or less than the above-described upper limit value, it is possible to make the balance between the deformation resistance to an external stress and the toughness of the polypropylene-based foam sheet 100 more favorable.

Here, the Young's modulus of the polypropylene-based foam sheet 100 can be obtained by measuring the Young's modulus respectively at one point in the MD direction and at one point in the TD direction in an environment of 23° C. and 50% RH under conditions of a test specimen shape of a strip shape, a test specimen width of 10 mm, an inter-chuck distance of 50 mm, and a tensile rate of 20 mm/minute, and employing the average value thereof.

The Young's modulus of the polypropylene-based foam sheet 100 can be controlled to be in the above-described range by appropriately controlling, for example, the kinds or blending amounts of the polypropylene-based resin, the inorganic filler, and the like, the expansion ratio of the polypropylene-based foam sheet 100, and the like respectively.

The arithmetic average roughness Ra of the polypropylene-based foam sheet 100 surface is preferably equal to or less than 2.5 μm from the viewpoint of further suppressing the generation of unevenness such as gloss unevenness or color unevenness, vertical stripes (flow patterns), or the like on the surface and making the appearance more favorable.

The lower limit of the arithmetic average roughness Ra of the polypropylene-based foam sheet 100 surface is not particularly limited and is, for example, equal to or more than 0.1 μm.

The arithmetic average roughness Ra of the polypropylene-based foam sheet 100 surface can be measured on the basis of JIS-B0601-1994.

Here, according to the present inventors' studies, it has been clarified that, in a polypropylene-based foam sheet including an inorganic filler at a high content ratio, unevenness such as gloss unevenness or color unevenness, vertical stripes (flow patterns), or the like are easily generated on the surface, and the appearance easily deteriorates. The present inventors carried out intensive studies on the basis of the above-described finding and thus found that, when an inorganic filler having a low moisture content ratio is used, it is possible to suppress the generation of unevenness such as color unevenness, vertical stripes (flow patterns), or the like, and a polypropylene-based foam sheet having a superior appearance can be obtained.

That is, in order to realize the polypropylene-based foam sheet 100 having the arithmetic average roughness Ra of the surface in the above-described range, it becomes important to appropriately select the kinds or blending amounts of the polypropylene-based resin, the inorganic filler, and the like, the expansion ratio of the polypropylene-based foam sheet 100, and the like respectively and use an inorganic filler having a low moisture content percentage.

The inorganic filler having a low moisture content percentage can be obtained by heating the inorganic filler and removing moisture adsorbed to the inside of the inorganic filler.

The total of the contents of the polypropylene-based resin and the inorganic filler in the polypropylene-based foam sheet 100 is preferably equal to or more than 50% by mass and equal to or less than 100% by mass, more preferably equal to or more than 70% by mass and equal to or less than 100% by mass, still more preferably equal to or more than 90% by mass and equal to or less than 100% by mass, and particularly preferably equal to or more than 95% by mass and equal to or less than 100% by mass when the entire polypropylene-based foam sheet 100 is set to 100% by mass. In such a case, it is possible to obtain a polypropylene-based foam sheet 100 having a superior balance among the lightweight property, the mechanical characteristics, the recycle property, the handleability, the appearance, the moldability, the moisture resistance, and the like.

The thickness of the polypropylene-based foam sheet 100 is not particularly limited and is, for example, equal to or more than 0.5 mm and equal to or less than 30 mm, preferably equal to or more than 1.0 mm and equal to or less than 20 mm, more preferably equal to or more than 1.5 mm and equal to or less than 12 mm, and still more preferably equal to or more than 2.0 mm and equal to or less than 9.0 mm. When the thickness of the polypropylene-based foam sheet 100 is in this range, the balance among the lightweight property, the mechanical characteristics, the recycle property, the handleability, the appearance, the moldability, and the like is superior.

Hereinafter, the respective components constituting the polypropylene-based foam sheet 100 will be described.

<Polypropylene-Based Resin>

The polypropylene-based foam sheet 100 includes a polypropylene-based resin as an essential component.

Examples of the polypropylene-based resin according to the present embodiment include a propylene homopolymer, a copolymer of propylene and ethylene or an α-olefin having 4 to 20 carbon atoms, and the like. As the α-olefin having 4 to 20 carbon atoms, 1-butene, 1-pentene, 1-hexene, 4-methyl-1-pentene, 1-octene, 1-decene, 1-dodecene, 1-tetradecene, 1-hexadecene, 1-octadecene, 1-eicosene, and the like are exemplified. Among these, ethylene or an α-olefin having 4 to 10 carbon atoms is preferred, and ethylene is more preferred. These α-olefins may form a random copolymer with propylene or may form a blocked copolymer. The content of a constituent unit derived from the α-olefin is preferably equal to or less than 5% by mole and more preferably equal to or less than 2% by mole in the polypropylene-based resin. The polypropylene-based resin in the polypropylene-based foam sheet 100 may be used singly or two or more polypropylene-based resins may be used in combination.

Among these, the polypropylene-based resin is preferably a propylene homopolymer since a polypropylene-based foam sheet 100 having a higher stiffness can be obtained.

The polypropylene-based resin according to the present embodiment can be produced using a variety of methods. For example, the polypropylene-based resin can be produced using a well-known catalyst such as a Ziegler-Natta-based catalyst or a metallocene-based catalyst.

A melt flow rate (MFR) of the polypropylene-based resin according to the present embodiment, which is based on ASTM D1238 and measured under conditions of 230° C. and a load of 2.16 kg, is preferably equal to or more than 0.5 g/10 minutes and more preferably equal to or more than 1 g/10 minutes from the viewpoint of the fluidity and the moldability and preferably equal to or less than 20 g/10 minutes, more preferably equal to or less than 10 g/10 minutes, and still more preferably equal to or less than 7 g/10 minutes from the viewpoint of further stabilizing the moldability and further suppressing the defoaming of foam cells.

From the viewpoint of a high melt tension and a high melt elongation and an excellent moldability, a Z average molecular weight (Mz)/weight-average molecular weight (Mw) of the polypropylene-based resin according to the present embodiment, which is measured by gel permeation chromatography (GPC), is preferably equal to or more than 7 and equal to or less than 20 and more preferably equal to or more than 10 and equal to or less than 20.

The polypropylene-based resin having an Mz/Mw value in the above-described range exhibits a broad molecular weight distribution and includes a large amount of a component having a high molecular weight and thus has a high melt tension and a high melt elongation and is excellent in terms of the moldability including foaming. Therefore, when the polypropylene-based resin having an Mz/Mw value in the above-described range is used, it is possible to improve the foam moldability of the polypropylene-based foam sheet 100 and make the uniformity of foam cells more favorable or further suppress the generation of holes in the polypropylene-based foam sheet 100 or sheet breakage even when the polypropylene-based foam sheet 100 is tightly filled with the inorganic filler and, consequently, a polypropylene-based foam sheet 100 having a superior appearance can be realized.

The content of the polypropylene-based resin having an Mz/Mw value in the above-described range is preferably equal to or more than 50% by mass and more preferably equal to or more than 60% by mass when the entire polypropylene-based resin included in the polypropylene-based foam sheet 100 is set to 100% by mass.

<Inorganic Filler>

The polypropylene-based foam sheet 100 according to the present embodiment includes an inorganic filler as an essential component.

As the inorganic filler, one or more selected from talc, mica, and silica is included from the viewpoint of obtaining a polypropylene-based foam sheet being excellent in terms of the lightweight property, the mechanical characteristics, the recycle property, the handleability, and the appearance. Among these, talc and mica are preferred from the viewpoint of the low price, and talc is more preferred from the viewpoint of the compatibility with the polypropylene-based resin, the foaming property, the moldability, the coloration property, the low price, the safety, and the like.

In addition, the inorganic filler may be used with no treatment carried out thereon or may be used with a treatment carried out on the surface with a silane coupling agent, a titanium coupling agent, a surfactant, or the like in order to improve the surface adhesiveness to the polypropylene-based resin and improve the dispersibility in the polypropylene-based resin.

In addition, the moisture content percentage of the inorganic filler according to the present embodiment is preferably equal to or less than 0.10% by mass, more preferably equal to or less than 0.08% by mass, still more preferably equal to or less than 0.07% by mass, far still more preferably equal to or less than 0.06% by mass, and particularly preferably equal to or less than 0.05% by mass of the entire inorganic filler. The lower limit of the moisture content percentage of the inorganic filler according to the present embodiment is not particularly limited and is, for example, equal to or more than 0.001% by mass of the entire inorganic filler.

Here, the moisture content percentage of the inorganic filler can be obtained by determining the amount of moisture generated by heating the inorganic filler in a nitrogen stream using a Karl Fischer coulometric titration method and computing the moisture content percentage from the obtained amount of moisture.

When an inorganic filler having a moisture content percentage being equal to or less than the above-described upper limit value is used, the generation of unevenness such as gloss unevenness or color unevenness, vertical stripes (flow patterns), or the like on the surface is suppressed or the uniformity of foam cells becomes more favorable, and it is possible to obtain a polypropylene-based multilayer foam sheet having an excellent appearance.

The inorganic filler having a moisture content percentage being equal to or less than the above-described upper limit value can be obtained by, for example, heating the inorganic filler at 80° C. to 150° C. for approximately 0.5 to 48 hours using a dehumidification dryer, a vacuum dryer, or the like to remove moisture adsorbed to the inside of the inorganic filler.

<Other Components>

Into the polypropylene-based foam sheet 100 according to the present embodiment, additive such as a heat stabilizer, an antioxidant, an ultraviolet absorber, a pigment, an antistatic agent, a copper inhibitor, a flame retardant, a neutralizer, a foaming agent, a plasticizer, a nucleating agent, a foam inhibitor, a crosslinking agent, a weathering stabilizer, a light stabilizer, an antiaging agent, a fatty acid metal salt, a softener, a dispersant, a colorant, a lubricant, a natural oil, a synthetic oil, and wax may be blended as necessary.

<Method for Producing Polypropylene-Based Foam Sheet>

The polypropylene-based foam sheet 100 can be obtained by, for example, foam-molding a polypropylene-based resin composition including an inorganic filler and a polypropylene-based resin to a sheet shape. A molding device and molding conditions are not particularly limited, and it is possible to employ a well-known molding device and well-known molding conditions of the related art.

(Method for Preparing Polypropylene-Based Resin Composition)

The polypropylene-based resin composition according to the present embodiment can be prepared by mixing or melting and kneading the respective components using a dry blend, a tumbler mixer, a Banbury mixer, a single screw extruder, a twin screw extruder, a high-speed twin screw extruder, a hot roll, or the like.

(Method of Molding Polypropylene-Based Foam Sheet)

The polypropylene-based foam sheet 100 can be obtained by, for example, foam-molding the polypropylene-based resin composition to a sheet shape using an extrusion molder.

As a foaming agent during the molding of the polypropylene-based foam sheet 100, a chemical foaming agent, carbon dioxide, and the like are exemplified.

As the chemical foaming agent, sodium bicarbonate, ammonium bicarbonate, a variety of carboxylates, sodium borohydride, azodicarbonamide, N,N-dinitrosopentamethylenetetramine, P,P-oxybis(benzenesulfonylhydrazide), azobisisobutyronitrile, paratoluenesulfonyl hydrazide, and the like are exemplified.

As the carbon dioxide, it is possible to supply carbon dioxide in any of a gas phase, a liquid phase, or a supercritical state.

The chemical foaming agent is preferably blended into and uniformly mixed with the polypropylene-based resin composition before being injected into the extraction molder.

In addition, in a case in which carbon dioxide is used as the foaming agent, carbon dioxide is preferably directly injected into the extrusion molder after the polypropylene-based resin composition has been in a kneaded and plasticized state in the extrusion molder.

The expansion ratio of the polypropylene-based resin composition is not particularly limited and can be appropriately determined in consideration of a variety of properties of the polypropylene-based foam sheet 100 to be obtained.

<Usages of Polypropylene-Based Foam Sheet>

The polypropylene-based foam sheet 100 is excellent in terms of the performance balance between the lightweight property and the mechanical characteristics and thus can be used as a replacement of wooden boards, particularly, a replacement of highly stiff wooden boards such as hardboards and medium-density fiberboards.

More specifically, the polypropylene-based foam sheet can be used as a construction material such as a floor material, a wall material, a door material, an interior material, an exterior material, or a window frame; furniture; an electric and electronic component; a partition material; a heat insulation material; a packing material; a car interior or exterior component; a cosmetic sheet; a toy; a curing board; a miscellaneous good; a sports component; or the like. Still more specifically, the polypropylene-based foam sheet can be used as a returnable box, a distribution container, a sleeper, a stiffening plate, a floor board, a curing board, a spacer, a signboard plate, a shelf board, a back board, a bottom plate, an inner sock, a ceiling material, a core material, a cushioning material, a sound-absorbing material, a reinforcement plate, a substrate plate, a tatami floor, a container, a component jig, a transportation material, a deck board, an event and disaster-related member, a concreate framework, a bed, a musical instrument, or the like.

2. Regarding Polypropylene-Based Foam Multilayer Sheet

FIG. 2 is a cross-sectional view schematically showing an example of the structure of a polypropylene-based foam multilayer sheet 200 of the embodiment according to the present invention.

The polypropylene-based foam multilayer sheet 200 according to the present embodiment includes a polypropylene-based foam layer 100 constituted of the polypropylene-based foam sheet 100 according to the present embodiment, a first non-foaming resin layer 110 that is provided on one surface of the polypropylene-based foam layer 100 and includes a thermoplastic resin and an inorganic filler, and a second non-foaming resin layer 120 that is provided on the other surface of the polypropylene-based foam layer 100 and includes a thermoplastic resin and an inorganic filler.

The polypropylene-based foam multilayer sheet 200 according to the present embodiment has non-forming inorganic filler-containing resin layers on the surfaces and is thus capable of improving the mechanical characteristics such as the bending characteristics or the tensile characteristics more than the polypropylene-based foam sheet 100 according to the present embodiment.

The thickness of the polypropylene-based foam multilayer sheet 200 according to the present embodiment is not particularly limited and is, for example, equal to or more than 0.5 mm and equal to or less than 30 mm, preferably equal to or more than 1.0 mm and equal to or less than 20 mm, more preferably equal to or more than 1.5 mm and equal to or less than 12 mm, and still more preferably equal to or more than 2.0 mm and equal to or less than 9.0 mm. When the thickness of the polypropylene-based foam multilayer sheet 200 is in this range, the balance among the lightweight property, the mechanical characteristics, the recycle property, the handleability, the appearance, the moldability, and the like is superior.

In addition, the thicknesses of the first non-foaming resin layer 110 and the second non-foaming resin layer 120 are not particularly limited, but preferably equal to or more than 0.05 mm and equal to or less than 5 mm and more preferably equal to or more than 0.1 mm and equal to or less than 3 mm respectively.

In addition, the ratio of the thickness of the first non-foaming resin layer 110 to the thickness of the polypropylene-based foam multilayer sheet 200 is preferably equal to or more than 0.01 and equal to or less than 0.5, more preferably equal to or more than 0.02 and equal to or less than 0.3, and still more preferably equal to or more than 0.05 and equal to or less than 0.2.

In addition, the ratio of the thickness of the second non-foaming resin layer 120 to the thickness of the polypropylene-based foam multilayer sheet 200 is preferably equal to or more than 0.01 and equal to or less than 0.5, more preferably equal to or more than 0.02 and equal to or less than 0.3, and still more preferably equal to or more than 0.05 and equal to or less than 0.2.

Hereinafter, the respective components constituting the first non-foaming resin layer 110 and the second non-foaming resin layer 120 according to the present embodiment will be described.

<Thermoplastic Resin>

The respective components constituting the first non-foaming resin layer 110 and the second non-foaming resin layer 120 according to the present embodiment includes a thermoplastic resin as an essential component.

As the thermoplastic resin according to the present embodiment, for example, a polyolefin-based resin can be used. Examples of the polyolefin-based resin include homopolymers of an α-olefin such as ethylene, propylene, butene-1, 3-methylbutene-1, 3-methylpentene-1, and 4-methylpentene-1, copolymers thereof, or copolymers of the homopolymer and another copolymerizable unsaturated monomer, and the like.

More specific examples thereof include polyethylene based resins such as high-density polyethylene, medium-density polyethylene, low-density polyethylene, linear low-density polyethylene, ultrahigh-molecular-weight polyethylene, ethylene-vinyl acetate copolymers, and ethylene-ethyl acrylate copolymers; polypropylene-based resins; polybutene-1; poly 4-methylpentene-1; and the like. The polyolefin-based resin may be used singly or two or more polyolefin-based resins may be used in combination. Among these, the polypropylene-based resins are preferred from the viewpoint of their excellent lightweight property, stiffness, tensile strength, scratch resistance, low-water-absorbing property, and heat resistance.

Examples of the polypropylene-based resin include the same polypropylene-based resin as that used for the above-described polypropylene-based foam sheet 100 according to the present embodiment.

<Inorganic Filler>

The respective components constituting the first non-foaming resin layer 110 and the second non-foaming resin layer 120 according to the present embodiment includes an inorganic filler as an essential component.

Examples of the inorganic filler include talc, mica, clay, wollastonite, calcium carbonate, magnesium carbonate, aluminum hydroxide, magnesium hydroxide, kaolin, pearlite, calcium sulfate, barium sulfate, potassium titanate, barium sulfate, calcium sulfite, calcium silicate, silica, diatomaceous earth, alumina, titanium oxide, a glass fiber, glass beads, glass balloons, a milled fiber, montmorillonite, bentonite, gufufite, aluminum powder, glass flakes, a carbon fiber, carbon flakes, carbon balloons, carbon beads, a carbon milled fiber, carbon black, graphite, a carbon nanotube, a ceramic fiber, molybdenum sulfide, aramid particles, an aramid fiber, a boron fiber, a silicon carbide fiber, a polyethylene fiber, a polypropylene fiber, a polyester fiber, a polyamide fiber, a polyarylate fiber, a variety of whiskers, wood powder, pulp, a cellulose nanofiber, chaff, paper sludge, and the like. These inorganic fillers can be used singly or two or more inorganic fillers can be used in combination.

Among these, as each of the inorganic fillers in the first non-foaming resin layer 110 and the second non-foaming resin layer 120, one or more selected from talc, mica, and silica is preferably included from the viewpoint of obtaining the polypropylene-based foam multilayer sheet 200 being excellent in terms of the lightweight property, the mechanical characteristics, the recycle property, the handleability, and the appearance. Among these, talc and mica are preferred from the viewpoint of the low price, and talc is more preferred from the viewpoint of the compatibility with the polypropylene-based resin, the foaming property, the moldability, the coloration property, the low price, the safety, and the like.

In addition, the inorganic filler may be used with no treatment carried out thereon or may be used with a treatment carried out on the surface with a silane coupling agent, a titanium coupling agent, a surfactant, or the like in order to improve the surface adhesiveness to the thermoplastic resin and improve the dispersibility in the thermoplastic resin.

In addition, the moisture content percentage of the inorganic filler according to the present embodiment is preferably equal to or less than 0.10% by mass, more preferably equal to or less than 0.08% by mass, still more preferably equal to or less than 0.07% by mass, far still more preferably equal to or less than 0.06% by mass, and particularly preferably equal to or less than 0.05% by mass of the entire inorganic filler. The lower limit of the moisture content percentage of the inorganic filler according to the present embodiment is not particularly limited and is, for example, equal to or more than 0.001% by mass of the entire inorganic filler.

Here, the moisture content percentage of the inorganic filler can be obtained by determining the amount of moisture generated by heating the inorganic filler in a nitrogen stream using a Karl Fischer coulometric titration method and computing the moisture content percentage from the obtained amount of moisture.

When an inorganic filler having a moisture content percentage being equal to or less than the above-described upper limit value is used, the generation of unevenness such as gloss unevenness or color unevenness, vertical stripes (flow patterns), or the like on the surface is suppressed, and it is possible to obtain a polypropylene-based multilayer foam multilayer sheet 200 having an excellent appearance.

The inorganic filler having a moisture content percentage being equal to or less than the above-described upper limit value can be obtained by, for example, heating the inorganic filler at 80° C. to 150° C. for approximately 0.5 to 48 hours using a dehumidification dryer, a vacuum dryer, or the like to remove moisture adsorbed to the inside of the inorganic filler.

The contents of the inorganic fillers in the first non-foaming resin layer 110 and the second non-foaming resin layer 120 are preferably equal to or more than 5 parts by mass, more preferably equal to or more than 15 parts by mass, still more preferably equal to or more than 25 parts by mass, far still more preferably equal to or more than 35 parts by mass, and particularly preferably equal to or more than 45 parts by mass respectively when the total amount of the thermoplastic resins and the inorganic fillers included in the first non-foaming resin layer 110 and the second non-foaming resin layer 120 is set to 100 parts by mass.

In addition, the contents of the inorganic fillers in first non-foaming resin layer 110 and the second non-foaming resin layer 120 are preferably equal to or less than 90 parts by mass, more preferably equal to or less than 80 parts by mass, still more preferably equal to or less than 70 parts by mass, and particularly preferably equal to or less than 65 parts by mass respectively when the total amount of the thermoplastic resins and the inorganic fillers included in the first non-foaming resin layer 110 and the second non-foaming resin layer 120 is set to 100 parts by mass.

When the contents of the inorganic fillers in the first non-foaming resin layer 110 and the second non-foaming resin layer 120 are set to equal to or more than the above-described lower limit value, it is possible to further improve the mechanical characteristics such as the bending characteristics or the tensile characteristics, the heat resistance, the moisture resistance, and the dimensional stability of the polypropylene-based foam multilayer sheet 200.

In addition, when the contents of the inorganic fillers in the first non-foaming resin layer 110 and the second non-foaming resin layer 120 are set to equal to or less than the above-described upper limit value, it is possible to make the balance between the lightweight property and the high stiffness of the polypropylene-based foam multilayer sheet 200 more favorable and further improve the molding of the polypropylene-based foam multilayer sheet 200 or suppress the generation of holes in the polypropylene-based foam multilayer sheet 200 or sheet breakage and, consequently, the polypropylene-based foam multilayer sheet 200 having a superior appearance can be realized.

In the polypropylene-based foam multilayer sheet 200 according to the present embodiment, the first non-foaming resin layer 110 and the second non-foaming resin layer 120 preferably have the same composition and the same thickness. In such a case, it is possible to make the linear expansion coefficients of the first non-foaming resin layer 110 and the second non-foaming resin layer 120 converge to approximately the same value, and thus it is possible to more effectively suppress a dimensional change caused by deformation such as warpage arising from a thermal stress or moisture absorption, and furthermore, it is possible to obtain the polypropylene-based foam multilayer sheet 200 being superior in terms of the mechanical characteristics such as the bending characteristics or the tensile characteristics and the heat resistance.

<Other Components>

Into the first non-foaming resin layer 110 and the second non-foaming resin layer 120 according to the present embodiment, additive such as a heat stabilizer, an antioxidant, an ultraviolet absorber, a pigment, an antistatic agent, a copper inhibitor, a flame retardant, a neutralizer, a foaming agent, a plasticizer, a nucleating agent, a foam inhibitor, a crosslinking agent, a weathering stabilizer, a light stabilizer, an antiaging agent, a fatty acid metal salt, a softener, a dispersant, a colorant, a lubricant, a natural oil, a synthetic oil, and wax may be blended as necessary.

<Method for Producing Polypropylene-Based Foam Multilayer Sheet>

The polypropylene-based foam multilayer sheet 200 according to the present embodiment can be obtained by, for example, forming resin layers constituted of an inorganic filler-containing thermoplastic resin composition including an inorganic filler and a thermoplastic resin on both surfaces of the polypropylene-based foam sheet 100 according to the present embodiment.

(Method for Preparing Inorganic Filler-Containing Thermoplastic Resin Composition)

The inorganic filler-containing thermoplastic resin composition according to the present embodiment can be prepared by mixing or melting and kneading the respective components using a dry blend, a tumbler mixer, a Banbury mixer, a single screw extruder, a twin screw extruder, a high-speed twin screw extruder, a hot roll, or the like.

(Method of Molding Polypropylene-Based Foam Multilayer Sheet)

Regarding the method for molding the polypropylene-based foam multilayer sheet 200 according to the present embodiment, the polypropylene-based foam multilayer sheet can be molded by, for example, a well-known method in which a multilayer extruder, a lamination molder, or the like is used. The polypropylene-based foam multilayer sheet 200 can be obtained by, for example, supplying the polypropylene-based resin composition for forming the polypropylene-based foam layer 100 and the inorganic filler-containing thermoplastic resin composition for forming the first non-foaming resin layer 110 and the second non-foaming resin layer 120 from the hoppers of the main extruder and the sub extruder of the multilayer extruder and carrying out the multilayer extrusion molding of the compositions to a sheet shape from the T die tip.

In addition, the polypropylene-based foam multilayer sheet 200 can also be obtained by molding the polypropylene-based foam layer 100, the first non-foaming resin layer 110, and the second non-foaming resin layer 120 separately and respectively, laminating these layers, and heating and molding the layers. In this case, for example, a thermal adhesive layer constituted of a polyolefin resin or the like having a low melting point may be interposed between the polypropylene-based foam layer 100 and the first non-foaming resin layer 110 or between the polypropylene-based foam layer 100 and the second non-foaming resin layer 120. The above-described polyolefin resin having a low melting point is not particularly limited, for example, a polypropylene-based resin can be used, and a random copolymer of propylene and an α-olefin is preferred.

<Usages of Polypropylene-Based Foam Multilayer Sheet>

The polypropylene-based foam multilayer sheet 200 according to the present embodiment is excellent in terms of the performance balance between the lightweight property and the mechanical characteristics and thus can be used as a replacement of wooden boards, particularly, a replacement of highly stiff wooden boards such as hardboards and medium-density fiberboards.

More specifically, the polypropylene-based foam multilayer sheet can be used as a construction material such as a floor material, a wall material, a door material, an interior material, an exterior material, or a window frame; furniture; an electric and electronic component; a partition material; a heat insulation material; a packing material; a car interior or exterior component; a cosmetic sheet; a toy; a curing board; a miscellaneous good; a sports component; or the like. Still more specifically, the polypropylene-based foam multilayer sheet can be used as a returnable box, a distribution container, a sleeper, a stiffening plate, a floor board, a curing board, a spacer, a signboard plate, a shelf board, a back board, a bottom plate, an inner sock, a ceiling material, a core material, a cushioning material, a sound-absorbing material, a reinforcement plate, a substrate plate, a tatami floor, a container, a component jig, a transportation material, a deck board, an event and disaster-related member, a concreate framework, a bed, a musical instrument, or the like.

Hitherto, the embodiment of the present invention has been described with reference to the drawings, but the embodiment is simply an example of the present invention, and it is possible to employ a variety of other constitutions.

### EXAMPLES

Hereinafter, the present invention will be specifically described on the basis of examples, but the present invention is not limited to these examples.

1. Measurement Methods

(1) Density of Polypropylene-Based Foam (Multilayer) Sheet

A test specimen was cut out from a polypropylene-based foam (multilayer) sheet, and the density was obtained by dividing the test specimen mass (g) by the volume (cm³) obtained from the external dimension of the test specimen.

(2) MFR of Polypropylene-Based Resin

The melt flow rate was based on ASTM D1238 and measured under conditions of 230° C. and a load of 2.16 kg.

(3) Mz/Mw of Polypropylene-Based Resin

A specimen (20 mg) was dissolved in a mobile phase for GPC measurement (20 ml) at 145° C., and the obtained solution was filtered using a sintered filter having a pore diameter of 1.0 μm, thereby obtaining a measurement sample.

Next, the Z average molecular weight (Mz) and the weight-average molecular weight (Mw) of the polypropylene-based resin were measured in the following manner using a gel permeation chromatograph manufactured by Tosoh Corporation (trade name: “HLC-8321 GPC/HT-type”), and Mz/Mw was computed.

As separation columns, two TSKgel GMH6-HTs (trade name) and two TSKgel GMH6-HTLs (trade name) were used. As the column sizes, the inner diameter was set to 7.5 mm, and the length was set to 300 mm for all of the columns. The column temperature was set to 140° C., o-dichlorobenzene (manufactured by Wako Pure Chemical Industries, Ltd.) was used as the mobile phase, and BHT (manufactured by Wako Pure Chemical Industries, Ltd.) (0.025% by weight) was used as an antioxidant.

The mobile phase was moved at a rate of 1.0 ml/minute, the specimen injection amount was set to 400 μl, and a differential refractometer was used as a detector. As the standard polystyrene, polystyrene manufactured by Tosoh Corporation was used. The molecular weight is a value converted to the polypropylene-based resin by universal correction.

(4) Bending Elastic Modulus of Polypropylene-Based Foam (Multilayer) Sheet

As the bending elastic modulus of the polypropylene-based foam (multilayer) sheet, with reference to the bending strength test described in JIS A5905, bending elastic moduli were measured respectively at one point in the MD direction and at one point in the TD direction in an environment of 23° C. and 50% RH under conditions of a test specimen thickness of 3 mm, a test specimen width of 50 mm, a test specimen length of 150 mm, an inter-span distance of 100 mm, and a bending rate of 50 mm/minute, and the average value thereof was employed.

(5) Young's Modulus of Polypropylene-Based Foam (Multilayer) Sheet

As the Young's modulus of polypropylene-based foam (multilayer) sheet, Young's moduli were measured respectively at one point in the MD direction and at one point in the TD direction in an environment of 23° C. and 50% RH under conditions of a test specimen shape of a strip shape, a test specimen width of 10 mm, an inter-chuck distance of 50 mm, and a tensile rate of 20 mm/minute, and the average value thereof was employed.

(6) Arithmetic Average Roughness Ra of Polypropylene-Based Foam (Multilayer) Sheet Surface

The arithmetic average roughness Ra of the polypropylene-based foam (multilayer) sheet surface was measured on the basis of JIS-B0601-1994 using a surface roughness measurement instrument manufactured by Tokyo Seimitsu Co., Ltd. (type: E-MD-S189A, sensing pin tip shape (tip radius: 2 μm, 60-degree cone, material: diamond)) under conditions of an evaluation length of 10 mm, a measurement rate of 0.3 mm/second, a cut-off value of 0.8 mm, and a measurement direction being parallel to the TD direction of the sheet surface.

(7) Moisture Content Percentage of Inorganic Filler

The moisture content percentage of the inorganic filler was computed using the following method. First, the amount of moisture generated by heating the inorganic filler at 200° C. for 15 minutes in a nitrogen stream (100 ml/minute) was determined using a Karl Fischer coulometric titration method. Next, the moisture content percentage of the inorganic filler was computed from the obtained amount of moisture.

(8) Appearance Evaluation of Polypropylene-Based Foam (Multilayer) Sheet

On the polypropylene-based foam (multilayer) sheet surface, the degree of vertical stripes (flow patterns) and unevenness (gloss unevenness and color unevenness) was visually observed and evaluated using the following standards.

A: There are no vertical stripes (flow patterns) and no unevenness (gloss unevenness and color unevenness), and the appearance is favorable.

B: Vertical stripes (flow patterns) and unevenness (gloss unevenness and color unevenness) are slightly observed.

C: Vertical stripes (flow patterns) and unevenness (gloss unevenness and color unevenness) are clearly visible, but there is no practical problem.

D: Sheet breakage or holes are observed, and there is a practical problem.

(9) Evaluation of Foam Cell Forms in Polypropylene-Based Foam (Multilayer) Sheet

The fine structure of foam cells in the polypropylene-based foam (multilayer) sheet was observed by X-ray CT scanning, and the foam cell forms were evaluated using the following standards.

◯: Foam cells are relatively uniform, and the cell shapes are favorable.

Δ: Foam cells fuse together, and air bubbles (voids) are observed near the sheet surface, but there is no practical problem.

X: Through holes are observed, and there is a practical problem.

(10) Evaluation of Performance Balance Between Lightweight Property and Mechanical Characteristics of Polypropylene-Based Foam (Multilayer) Sheet

The specific bending elastic modulus (bending elastic modulus/density) of the polypropylene-based foam (multilayer) sheet was computed and the performance balance between the lightweight property and the mechanical characteristics of the polypropylene-based foam (multilayer) sheet was evaluated using the following standards.

AA: The specific bending elastic modulus is more than 4.0 GPa·cm³/g.

A: The specific bending elastic modulus is more than 3.0 GPa·cm³/g and equal to or less than 4.0 GPa·cm³/g.

B: The specific bending elastic modulus is more than 2.5 GPa·cm³/g and equal to or less than 3.0 GPa·cm³/g.

C: The specific bending elastic modulus is equal to or less than 2.5 GPa·cm³/g.

2. Raw Materials Raw materials used in examples and comparative examples will be described below.

(1) Polypropylene-Based Resin

PP1: Propylene homopolymer (VP103W manufactured by Prime Polymer Co., Ltd., MFR: 3 g/10 minutes, Mz/Mw value: 14)

PP2: Propylene homopolymer (WB140HMS manufactured by Borealis, MFR: 2.1 g/10 minutes, Mz/Mw value: 7)

(2) Master Batch Containing Inorganic Filler and Polypropylene-Based Resin

PP talc MB1 (manufactured by Mitsufuku Industry Co., Ltd., brand: MFP-TP20, composition: 20% by mass of propylene homopolymer and 80% by mass of talc contained, moisture content percentage of talc: 0.15% by mass)

PP talc MB2 (a master batch obtained by heating PP talc MB1 at 105° C. for 18 hours and reducing the moisture content percentage of talc to 0.05% by mass)

PP mica MB (manufactured by Shiraishi Calcium Kaisha, Ltd., a master batch obtained by heating brand: HIFILLMERMAT-MPH80-60 (MFR: 3 g/10 minutes, composition: 20% by mass of polypropylene made of a blocked copolymer and 80% by mass of mica contained, moisture content percentage of mica: 0.20% by mass) at 120° C. for 18 hours and reducing the moisture content percentage of mica to 0.075% by mass)

PP calcium carbonate MB (manufactured by Toyo Ink Co., Ltd., a master batch obtained by heating brand: PPM10245AL (20% by mass of propylene homopolymer and 80% by mass of calcium carbonate contained) at 120° C. for 18 hours)

Meanwhile, PP talc MB1 was used with no changes applied to a commercially available general-purpose product.

3. Production of Polypropylene-Based Foam (Multilayer) Sheets

### Examples 1 to 12 and Comparative Examples 1 to 4

As a molder, a device including a single screw extruder (cylinder inner diameter D: 50 mm, full flight screws, L/D: 32 mm (here, L represents the screw effective length), carbon dioxide supply location: 17.5 D from the screw supply portion side), a T die (die width: 320 mm, lip opening: 0.5 mm), a cooling roll (outer diameter: 50 mm, made of mirror-finished hard chromium-plated steel, water-cooling type), a carbon dioxide supply device, and a drawer was used.

First, the respective raw materials were respectively blended according to formulae (the units in the table are ‘parts by mass’) shown in Table 1, the obtained mixtures were injected into the hopper, and furthermore, carbon dioxide was poured into the middle (location: 17.5D) of the cylinder of the extrusion molder from the carbon dioxide supply device at a pressure of 10 to 19 MPa. The amount of carbon dioxide poured in at this time was adjusted so as to reach 0.17 to 0.33% by mass of the extrusion amount. The respective component raw materials were melted and kneaded under conditions of the temperatures of the respective portions of the cylinder being 173° C. to 193° C. and a screw rotation rate of 30 to 55 rpm and extruded from the T die at a resin temperature in the cylinder head portion being 186° C. to 215° C. so that the extrusion amount reached 10 to 19 kg/hour. The extruded foam sheets were cooled using the cooling roll (the temperature of the passing water in the roll being 45° C.) and drawn (at a drawing rate of 0.4 to 0.7 m/minute) using the drawer, thereby respectively obtaining polypropylene-based foam sheets having a sheet width of approximately 300 mm. The respective evaluations were carried out using the obtained polypropylene-based foam sheets. The obtained results are shown in Table 1 respectively.

### Comparative Example 5

The respective evaluations were carried out using PAULOWNIA (registered trademark) manufactured by Mitsui Chemicals Tohcello Inc. as a polypropylene-based foam sheet including no inorganic filler. The obtained results are shown in Table 1.

### Examples 13 to 19

The respective raw materials were injected into the hopper of the extrusion molder used in Examples 1 to 12 according to formulae (the units in the table are ‘parts by mass’) shown in Table 2, the respective raw materials were melted and kneaded under conditions of a cylinder temperature being 205° C. to 215° C., a die temperature being 220° C., and a screw rotation rate of 22 to 28 rpm and extruded from the T die at a resin temperature in the cylinder head portion being 229° C. to 231° C. so that the extrusion amount reached 8 to 13 kg/hour. The extruded foam sheets were drawn at a drawing rate of 1.0 m/minute using the drawer, thereby respectively obtaining polypropylene-based non-foaming sheets 1 to 7 having a sheet width of 290 to 300 mm.

Next, polypropylene-based foam multilayer sheets were respectively produced according to layer constitutions shown in Table 3, and the respective evaluations were carried out. The obtained results are shown in Table 3 respectively.

Here, in the polypropylene-based foam multilayer sheets, thermal adhesive layers (a polypropylene film made of a random copolymer having a melting point of 139° C., thickness: 0.07 mm) were inserted between the respective layers and laminated. Furthermore, in the top and bottom flat portions of the multilayer sheet which came into contact with press platens of a hot press device and a cold press device, polyimide films having heat resistance and a mirror surface (arithmetic average roughness Ra of equal to or less than 0.1 μm, thickness: 0.1 mm) were disposed on the top and bottom of the well-overlaid multilayer sheet in order to impart surface flatness and a mold release property from the press platen.

The polypropylene-based foam multilayer sheets were hot-pressed at a temperature of 150° C. and a pressure of 2.5 MPa for eight minutes using the hot press device and then hot-pressed at a temperature of 150° C. and a pressure of 10 MPa for one minute. After that, the multilayer sheets including the top and bottom polyimide films were inserted into the cold press device and cooled at a temperature of 25° C. and a pressure of 5 MPa. Meanwhile, 3 mm or 2.6 mm-thick metal frames which served as spacers had been disposed around the inside of the top and bottom polyimide films and the outside of the respective multilayer sheets in advance before hot pressing. In the above-described manner, polypropylene-based foam multilayer sheets having a total thickness of approximately 2.8 to 3.0 mm or 2.6 mm after thermal adhesion and cooling were obtained respectively.

TABLE 1

| | | | | | | | | | | | Example |
|---|---|---|---|---|---|---|---|---|---|---|---|
| | | Example 1 | Example 2 | Example 3 | Example 4 | Example 5 | Example 6 | Example 7 | Example 8 | Example 9 | 10 |
| Formula | PP1 (Mz/Mw: 14) | 75 | 75 | 62.5 | 62.5 | 50 | 50 | 37.5 | 37.5 | 25 | 25 |
| [parts by | PP2 (Mz/Mw: 7) | — | — | — | — | — | — | — | — | — | — |
| mass] | PP talc MB1 | 25 | — | 37.5 | — | 50 | | 62.5 | | 75 | — |
| | (moisture | | | | | | | | | | |
| | content | | | | | | | | | | |
| | percentage of | | | | | | | | | | |
| | talc: 0.15% by | | | | | | | | | | |
| | mass) | | | | | | | | | | |
| | PP talc MB2 | — | 25 | — | 37.5 | — | 50 | | 62.5 | | 75 |
| | (moisture | | | | | | | | | | |
| | content | | | | | | | | | | |
| | percentage of | | | | | | | | | | |
| | talc: 0.05% by | | | | | | | | | | |
| | mass) | | | | | | | | | | |
| | PP mica MB | — | — | — | — | — | — | — | — | — | — |
| | (moisture | | | | | | | | | | |
| | content | | | | | | | | | | |
| | percentage of | | | | | | | | | | |
| | mica: 0.075% by | | | | | | | | | | |
| | mass) | | | | | | | | | | |
| | PP calcium | — | — | — | — | — | — | — | — | — | — |
| | carbonate MB | | | | | | | | | | |
| Content of inorganic filler | | 20 | 20 | 30 | 30 | 40 | 40 | 50 | 50 | 60 | 60 |
| [parts by mass] | | | | | | | | | | | |
| Evaluation | Sheet thickness | 3.0 | 2.8 | 2.6 | 2.7 | 2.4 | 2.5 | 2.3 | 2.1 | 1.4 | 1.6 |
| results | [mm] | | | | | | | | | | |
| | Density [g/cm³] | 0.47 | 0.45 | 0.40 | 0.42 | 0.47 | 0.50 | 0.59 | 0.62 | 0.96 | 0.77 |
| | Bending elastic | 1.3 | 1.3 | 1.4 | 1.4 | 1.6 | 1.6 | 1.8 | 2.0 | 4.0 | 3.9 |
| | modulus [GPa] | | | | | | | | | | |
| | Specific bending | 2.8 | 2.9 | 3.5 | 3.3 | 3.4 | 3.2 | 3.1 | 3.2 | 4.2 | 5.1 |
| | elastic modulus | | | | | | | | | | |
| | (=bending | | | | | | | | | | |
| | elastic | | | | | | | | | | |
| | modulus/density) | | | | | | | | | | |
| | [GPa · cm³/g] | | | | | | | | | | |
| | Young's modulus | 0.4 | 0.3 | 0.6 | 0.6 | 0.5 | 0.7 | 0.9 | 0.9 | 1.5 | 1.3 |
| | [GPa] | | | | | | | | | | |
| | Specific Young's | 0.9 | 0.7 | 1.5 | 1.4 | 1.1 | 1.4 | 1.5 | 1.5 | 1.6 | 1.7 |
| | modulus | | | | | | | | | | |
| | (=Young's | | | | | | | | | | |
| | modulus/density) | | | | | | | | | | |
| | [GPa · cm³/g] | | | | | | | | | | |
| | Arithmetic | 2.6 | 1.5 | 3.1 | 2.5 | 3.2 | 2.5 | 2.7 | 2.4 | 3.1 | 2.1 |
| | average | | | | | | | | | | |
| | roughness Ra | | | | | | | | | | |
| | [μm] | | | | | | | | | | |
| | Performance | B | B | A | A | A | A | A | A | AA | AA |
| | balance between | | | | | | | | | | |
| | lightweight | | | | | | | | | | |
| | property and | | | | | | | | | | |
| | mechanical | | | | | | | | | | |
| | characteristics | | | | | | | | | | |
| | Sheet appearance | C | A | C | A | C | A | B | A | C | A |
| | Foam cell form | Not | Not | Not | Not | ∘ | ∘ | ∘ | ∘ | Δ | ∘ |
| | | observed | observed | observed | observed | | | | | | |

| | | | | Comparative | Comparative | Comparative | Comparative | Comparative |
|---|---|---|---|---|---|---|---|---|
| | | Example 11 | Example 12 | Example 1 | Example 2 | Example 3 | Example 4 | Example 5 |
| Formula | PP1 (Mz/Mw: 14) | — | 50 | 87.5 | 87.5 | 12.5 | 50 | PP foam |
| [parts by | PP2 (Mz/Mw: 7) | 37.5 | — | — | — | — | — | sheet |
| mass] | PP talc MB1 | — | — | 12.5 | — | — | — | including |
| | (moisture | | | | | | | no |
| | content | | | | | | | inorganic |
| | percentage of | | | | | | | filler |
| | talc: 0.15% by | | | | | | | |
| | mass) | | | | | | | |
| | PP talc MB2 | 62.5 | — | — | 12.5 | 87.5 | — | |
| | (moisture | | | | | | | |
| | content | | | | | | | |
| | percentage of | | | | | | | |
| | talc: 0.05% by | | | | | | | |
| | mass) | | | | | | | |
| | PP mica MB | — | 50 | — | — | — | — | |
| | (moisture | | | | | | | |
| | content | | | | | | | |
| | percentage of | | | | | | | |
| | mica: 0.075% by | | | | | | | |
| | mass) | | | | | | | |
| | PP calcium | — | — | — | — | — | 50 | |
| | carbonate MB | | | | | | | |
| Content of inorganic filler | | 50 | 40 | 10 | 10 | 70 | 40 | — |
| [parts by mass] | | | | | | | | |
| Evaluation | Sheet thickness | 1.7 | 2.4 | 2.8 | 2.5 | Molding of | 2.5 | 3.0 |
| results | [mm] | | | | | foam sheet | | |
| | Density [g/cm³] | 0.50 | 0.52 | 0.48 | 0.49 | is difficult | 0.68 | 0.30 |
| | Bending elastic | 1.5 | 1.6 | 1.2 | 1.2 | | 1.4 | 0.57 |
| | modulus [GPa] | | | | | | | |
| | Specific bending | 3.0 | 3.1 | 2.5 | 2.4 | | 2.1 | 1.9 |
| | elastic modulus | | | | | | | |
| | (=bending | | | | | | | |
| | elastic | | | | | | | |
| | modulus/density) | | | | | | | |
| | [GPa · cm³/g] | | | | | | | |
| | Young's modulus | 0.8 | 0.8 | 0.3 | 0.3 | | 0.8 | 0.2 |
| | [GPa] | | | | | | | |
| | Specific Young's | 1.6 | 1.5 | 0.6 | 0.6 | | 1.2 | 0.7 |
| | modulus | | | | | | | |
| | (=Young's | | | | | | | |
| | modulus/density) | | | | | | | |
| | [GPa · cm³/g] | | | | | | | |
| | Arithmetic | 4.5 | 2.0 | 5.2 | 1.3 | | 1.2 | 1.3 |
| | average | | | | | | | |
| | roughness Ra | | | | | | | |
| | [μm] | | | | | | | |
| | Performance | A | A | C | C | | C | C |
| | balance between | | | | | | | |
| | lightweight | | | | | | | |
| | property and | | | | | | | |
| | mechanical | | | | | | | |
| | characteristics | | | | | | | |
| | Sheet appearance | B | C | C | A | | B | — |
| | Foam cell form | Not | Not | Not observed | Not observed | | Not observed | — |
| | | observed | observed | | | | | |

TABLE 2

| | | Polypropylene-based non-foaming | | | | | | |
|---|---|---|---|---|---|---|---|---|
| | | sheet | | | | | | |
| | | 1 | 2 | 3 | 4 | 5 | 6 | 7 |
| Formula [part by | PP1 | 75 | 62.5 | 50 | 37.5 | 25 | — | — |
| mass] | PP2 | — | — | — | — | — | 37.5 | 50 |
| | PP talc MB2 | 25 | 37.5 | 50 | 62.5 | 75 | 62.5 | — |
| | PP mica MB | — | — | — | — | — | — | 50 |

| | | | | | | | |
|---|---|---|---|---|---|---|---|
| Content of inorganic filler [part | 20 | 30 | 40 | 50 | 60 | 50 | 40 |
| by mass] | | | | | | | |

TABLE 3

| | | Example 13 | Example 14 | Example 15 | Example 16 |
|---|---|---|---|---|---|
| Layer | First non-foaming resin layer | Polypropylene-based | Polypropylene-based | Polypropylene-based | Polypropylene-based |
| constitution | | non-foaming sheet 1 | non-foaming sheet 2 | non-foaming sheet 3 | non-foaming sheet 4 |
| | Polypropylene-based foam layer | Sheet of Example 2 | Sheet of Example 4 | Sheet of Example 6 | Sheet of Example 8 |
| | Second non-foaming resin layer | Polypropylene-based | Polypropylene-based | Polypropylene-based | Polypropylene-based |
| | | non-foaming sheet 1 | non-foaming sheet 2 | non-foaming sheet 3 | non-foaming sheet 4 |
| Multilayer | Thickness of spacer metal frame | 3.0 | 3.0 | 3.0 | 3.0 |
| sheet | [mm] | | | | |
| production | | | | | |
| condition | | | | | |
| Evaluation | Sheet thickness [mm] | 3.0 | 3.0 | 2.9 | 2.9 |
| results | Density [g/cm³] | 0.81 | 0.79 | 0.84 | 0.91 |
| | Bending elastic modulus [GPa] | 2.8 | 4.8 | 5.6 | 6.8 |
| | Specific bending elastic | 3.5 | 6.1 | 6.7 | 7.5 |
| | modulus (=bending elastic | | | | |
| | modulus/density) [GPa · cm³/g] | | | | |
| | Young's modulus [GPa] | 1.3 | 1.2 | 1.3 | 1.6 |
| | Specific Young's modulus | 1.6 | 1.5 | 1.5 | 1.8 |
| | (=Young's modulus/density) | | | | |
| | [GPa · cm³/g] | | | | |
| | Arithmetic average roughness | 0.4 | 0.7 | 1.0 | 1.1 |
| | Ra [μm] | | | | |
| | Performance balance between | A | AA | AA | AA |
| | lightweight property and | | | | |
| | mechanical characteristics | | | | |
| | Sheet appearance | B | A | A | A |
| | Foam cell form | Not observed | Not observed | ∘ | ∘ |

| | | Example 17 | Example 18 | Example 19 |
|---|---|---|---|---|
| Layer | First non-foaming resin layer | Polypropylene-based | Polypropylene-based | Polypropylene-based |
| constitution | | non-foaming sheet 5 | non-foaming sheet 6 | non-foaming sheet 7 |
| | Polypropylene-based foam layer | Sheet of Example 10 | Sheet of Example 11 | Sheet of Example 12 |
| | Second non-foaming resin layer | Polypropylene-based | Polypropylene-based | Polypropylene-based |
| | | non-foaming sheet 5 | non-foaming sheet 6 | non-foaming sheet 7 |
| Multilayer | Thickness of spacer metal frame | 3.0 | 2.6 | 3.0 |
| sheet | [mm] | | | |
| production | | | | |
| condition | | | | |
| Evaluation | Sheet thickness [mm] | 2.8 | 2.6 | 3.0 |
| results | Density [g/cm³] | 0.94 | 0.82 | 0.80 |
| | Bending elastic modulus [GPa] | 8.2 | 3.9 | 5.2 |
| | Specific bending elastic | 8.7 | 4.8 | 6.5 |
| | modulus (=bending elastic | | | |
| | modulus/density) [GPa · cm³/g] | | | |
| | Young's modulus [GPa] | 1.8 | 1.5 | 1.4 |
| | Specific Young's modulus | 1.9 | 1.8 | 1.8 |
| | (=Young's modulus/density) | | | |
| | [GPa · cm³/g] | | | |
| | Arithmetic average roughness | 1.7 | 1.1 | 3.8 |
| | Ra [μm] | | | |
| | Performance balance between | AA | AA | AA |
| | lightweight property and | | | |
| | mechanical characteristics | | | |
| | Sheet appearance | A | A | C |
| | Foam cell form | ∘ | Not observed | Not observed |

As is clear from Tables 1 and 3, it was found that the polypropylene-based foam sheets of Examples 1 to 12 in which the content of the inorganic filler was equal to or more than 15 parts by mass and equal to or less than 65 parts by mass and the polypropylene-based foam multilayer sheets of Examples 13 to 19 including the polypropylene-based foam layer in which the content of the inorganic filler was equal to or more than 15 parts by mass and equal to or less than 65 parts by mass exhibited values on the same level as those of wooden boards such as hardboards or medium-density fiberboards and the performance balance between the lightweight property and the mechanical characteristics was excellent. That is, it is possible to understand that the polypropylene-based foam sheet 100 according to the present embodiment is preferable as a replacement of wooden boards.

On the other hand, all of the polypropylene-based foam sheets of Comparative Examples 1, 2, 4, and 5 were poor in terms of the performance balance between the lightweight property and the mechanical characteristics. In addition, in the polypropylene-based foam sheet of Comparative Example 3, the expansion ratio did not increase, the surface was roughened, the molding of the foam sheet was difficult, and the acquisition of a foam sheet was difficult.

This application claims priority on the basis of Japanese Patent Application No. 2016-213791, filed on Oct. 31, 2016, the content of which is incorporated herein by reference.

1. A polypropylene-based foam sheet comprising:
a polypropylene-based resin; and
an inorganic filler,
wherein the inorganic filler includes one or more selected from talc, mica, and silica, and
a content of the inorganic filler in the polypropylene-based foam sheet is equal to or more than 15 parts by mass and equal to or less than 65 parts by mass when a total amount of the polypropylene-based resin and the inorganic filler is set to 100 parts by mass.

2. The polypropylene-based foam sheet according to claim 1,
wherein the inorganic filler includes talc.

3. The polypropylene-based foam sheet according to claim 1,
wherein a density of the polypropylene-based foam sheet is equal to or less than 1.0 g/cm³.

4. The polypropylene-based foam sheet according to claim 1,
wherein a bending elastic modulus of the polypropylene-based foam sheet, which is measured in an environment of 23° C. and 50% RH, is equal to or more than 1.0 GPa.

5. The polypropylene-based foam sheet according to claim 1,
wherein a Young's modulus of the polypropylene-based foam sheet, which is measured in an environment of 23° C. and 50% RH under conditions of a test specimen shape of a strip shape, a test specimen width of 10 mm, an inter-chuck distance of 50 mm, and a tensile rate of 20 mm/minute, is equal to or more than 0.3 GPa.

6. The polypropylene-based foam sheet according to claim 1,
wherein an arithmetic average roughness Ra of a surface of the polypropylene-based foam sheet, which is measured on the basis of JIS-B0601-1994, is equal to or less than 2.5 μm.

7. The polypropylene-based foam sheet according to claim 1,
wherein a total of contents of the polypropylene-based resin and the inorganic filler in the polypropylene-based foam sheet is equal to or more than 50% by mass and equal to or less than 100% by mass when the entire polypropylene-based foam sheet is set to 100% by mass.

8. The polypropylene-based foam sheet according to claim 1,
wherein a melt flow rate of the polypropylene-based resin, which is based on ASTM D1238 and measured under conditions of 230° C. and a load of 2.16 kg, is equal to or more than 0.5 g/10 minutes and equal to or less than 20 g/10 minutes.

9. The polypropylene-based foam sheet according to claim 1,
wherein a Z average molecular weight (Mz)/weight-average molecular weight (Mw) of the polypropylene-based resin, which is measured by gel permeation chromatography (GPC), is equal to or more than 7 and equal to or less than 20.

10. The polypropylene-based foam sheet according to claim 1,
wherein a thickness of the polypropylene-based foam sheet is equal to or more than 0.5 mm and equal to or less than 30 mm.

11. The polypropylene-based foam sheet according to claim 1 which is used as a replacement of a wooden board.

12. A polypropylene-based foam multilayer sheet comprising:
a polypropylene-based foam layer constituted of the polypropylene-based foam sheet according to claim 1;
a first non-foaming resin layer that is provided on one surface of the polypropylene-based foam layer and includes a thermoplastic resin and an inorganic filler; and
a second non-foaming resin layer that is provided on the other surface of the polypropylene-based foam layer and includes a thermoplastic resin and an inorganic filler.

13. The polypropylene-based foam multilayer sheet according to claim 12,
wherein thicknesses of the first non-foaming resin layer and the second non-foaming resin layer are respectively equal to or more than 0.05 mm and equal to or less than 5 mm.

14. The polypropylene-based foam multilayer sheet according to claim 12,
wherein a ratio of the thickness of the first non-foaming resin layer to a thickness of the entire polypropylene-based foam multilayer sheet is equal to or more than 0.01 and equal to or less than 0.5, and
a ratio of the thickness of the second non-foaming resin layer to the thickness of the entire polypropylene-based foam multilayer sheet is equal to or more than 0.01 and equal to or less than 0.5.

15. The polypropylene-based foam multilayer sheet according to claim 12,
wherein the inorganic fillers in the first non-foaming resin layer and the second non-foaming resin layer respectively include one or more selected from talc, mica, and silica.

16. The polypropylene-based foam multilayer sheet according to claim 12,
wherein contents of the inorganic fillers in the first non-foaming resin layer and the second non-foaming resin layer are respectively equal to or more than 5 parts by mass and equal to or less than 90 parts by mass when a total amount of the thermoplastic resins and the inorganic fillers included in the first non-foaming resin layer and the second non-foaming resin layer is set to 100 parts by mass.

17. The polypropylene-based foam multilayer sheet according to claim 12,
wherein the first non-foaming resin layer and the second non-foaming resin layer have the same composition and the same thickness.

18. The polypropylene-based foam multilayer sheet according to claim 12 which is used as a replacement of a wooden board.
